(19) United States
(12) Patent Application Publication
(10) Pub. No.: US 2007/0271520 A1
(43) Pub. Date: Nov. 22, 2007

(54) Method for transforming a graphical user interface

(75) Inventors: Alan R. Yee, Millbrae, CA (US); Timothy M. Dunn, Vallecito, CA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/437,898

(22) Filed: May 19, 2006

(51) Int. Cl. G06F 17/00

(52) U.S. Cl. 715/746

(57) ABSTRACT

A computer readable medium includes executable instructions for transforming a graphical user interface by accessing a transformation mode of the graphical user interface, where the graphical user interface includes multiple graphical elements, selecting a first graphical element from the multiple graphical elements, receiving a transformation value associated with a transformation of the first graphical element, and applying the transformation to the first graphical element to obtain a transformed graphical user interface.

### CROSS-REFERENCE TO RELATED APPLICATIONS

The present application contains subject matter that may be related to subject matter contained in U.S. patent application Ser. No. 11/282,346, entitled “Displaying Consumer Device Graphics Using Scalable Vector Graphics” and filed Nov. 18, 2005, the entire contents of which are incorporated herein by reference. The referenced application has the same inventors and assignee as the present application.

### BACKGROUND

As the number of functions of a software application increases, so does the number of controls presented to a user of the software application. However, a large number of controls can clutter a user interface. For example, as the number of controls increases, the amount of space in the user interface available to each control decreases, thereby limiting the size of each control. When a user interface is cluttered, even those controls that are the most important and/or most frequently used may be difficult to locate and/or use.

To reduce clutter in user interfaces, some software applications offer functionality to select the controls that are available. In other words, a user may explicitly select specific controls to add or remove from a user interface. However, when a control is removed from the user interface, the control is no longer available for use.

Further, some software applications offer functionality to move controls to specific regions of a user interface. However, although a control is relocated, its visual presentation (e.g. its size, orientation, shape, color, etc.) does not change. Accordingly, its visibility in the user interface also does not change. Thus, the control may not be any easier or harder to locate and/or use. Typically, software applications do not offer any other functionality to modify controls, beyond global resizing controls (i.e., resizing all icons or resizing the entire user interface).

### SUMMARY

In general, in one aspect, the invention relates to a computer readable medium comprising executable instructions for transforming a graphical user interface by accessing a transformation mode of the graphical user interface, wherein the graphical user interface comprises a plurality of graphical elements, selecting a first graphical element from the plurality of graphical elements, receiving a transformation value associated with a transformation of the first graphical element, and applying the transformation to the first graphical element to obtain a transformed graphical user interface.

In general, in one aspect, the invention relates to a computer readable medium comprising executable instructions for transforming a graphical user interface by obtaining a first element filter associated with a first graphical element of the graphical user interface, obtaining a second element filter associated with a second graphical element of the graphical user interface, using a filter operation to combine the first element filter and the second element filter, to create a filter combination associated with the first graphical element and the second graphical element, and transforming the first graphical element and the second graphical element, using the filter combination, to generate a transformed graphical user interface.

In general, in one aspect, the invention relates to a graphical user interface displaying a transformation mode of a graphical user interface, comprising a plurality of graphical elements of the graphical user interface, wherein each graphical element in the plurality of graphical elements is configured to be selected, and an element transformation control configured to accept a transformation value, wherein the transformation value is associated with a transformation of a selected graphical element, and wherein applying the transformation to the selected graphical element results in a transformed graphical user interface.

Other aspects of the invention will be apparent from the following description and the appended claims.

### BRIEF DESCRIPTION OF DRAWINGS

FIG. 1 shows a flow chart in accordance with one or more embodiments of the invention.

FIGS. 2-6 show diagrams of a graphical user interface in accordance with one or more embodiments of the invention.

FIG. 7 shows a flow chart in accordance with one or more embodiments of the invention.

FIG. 8 shows a diagram of set operations in accordance with one or more embodiments of the invention.

FIGS. 9A-9C show diagrams of element filters in accordance with one or more embodiments of the invention.

FIG. 10 shows a diagram of a graphical user interface in accordance with one or more embodiments of the invention.

FIG. 11 shows a diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method for transforming a graphical user interface (GUI). Specifically, in one or more embodiments of the invention, a transformation mode of the graphical user interface is accessed, in which one or more graphical elements are selected. The selected graphical elements are then transformed to obtain a transformed graphical user interface.

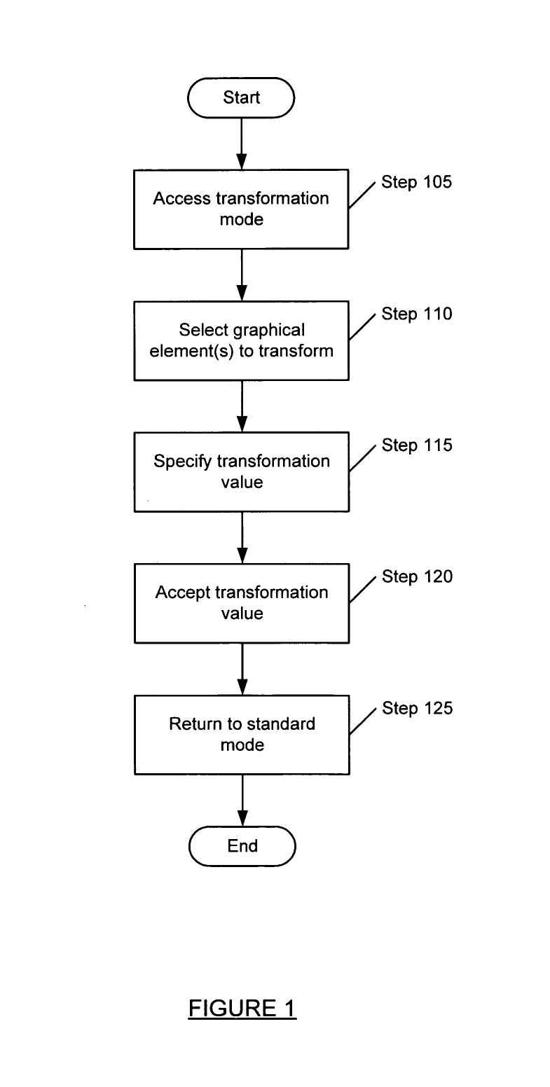

FIG. 1 shows a flow chart in accordance with one or more embodiments of the invention. Specifically, FIG. 1 shows a flow chart of a method for transforming a graphical user interface in accordance with one or more embodiments of the invention.

Initially, a transformation mode of a graphical user interface is accessed (Step 105). In one or more embodiments of the invention, the transformation mode may be a subcomponent of the graphical user interface, a non-functional subcomponent of the graphical user interface (i.e., a version in which the typical functionality of one or more graphical elements is disabled), an overlay of the graphical user interface, a zoomed subcomponent of the graphical user interface (i.e., a version made visually larger or smaller), any other type of mode or interface, or any combination thereof.

Those skilled in the art will appreciate that a normal mode of the graphical user interface (i.e., a mode wherein all graphical elements retain their typical functionality) may or may not remain viewable and/or accessible when the transformation mode is accessed. In one or more embodiments of the invention, the transformation mode may include controls associated with transformation functionality. Examples of such controls are discussed in detail below.

Returning to discussion of FIG. 1, one or more graphical elements to transform are then selected (Step 110). In one or more embodiments of the invention, a selection of graphical element(s) may be referred to as an “element filter.” Element filters are discussed in detail below. In one or more embodiments of the invention, a graphical element selected may be an image, text, button, scrollbar, menu item, icon, or any other type of element in the graphical user interface. Those skilled in the art will appreciate that in one or more embodiments of the invention, an element filter may include many different types of graphical elements.

In one or more embodiments of the invention, selecting a graphical element to transform may involve selecting a transformation version of the graphical element (i.e., a version displayed only while in transformation mode), selecting a control associated with the graphical element, entering text associated with the graphical element, selecting a title of the graphical element from a menu, or any other type of selection. Those skilled in the art will appreciate that selecting a graphical element may involve using a keyboard, mouse, stylus, light pen, microphone, or any other type of input device.

In one or more embodiments of the invention, the graphical element selected may be a scaled vector graphic (SVG). Additional information about scaled vector graphics is available in U.S. patent application Ser. No. 11/282,346, referenced above. Those skilled in the art will appreciate that using scaled vector graphics provides for efficient transformation of graphical elements without significant loss in resolution of the graphical elements.

Next, a transformation value is received for the graphical element(s) selected (Step 115). Specifically, the transformation value is associated with a transformation of the graphical element(s). More specifically, in one or more embodiments of the invention, the transformation may be a resizing (i.e., an increase of length and/or height, an expansion, a reduction, or any other type of resizing), a rotation, a color change, an alpha blending (e.g., application of transparency) an underlining, a hiding, a revealing, an application of a visual pattern (e.g., stripes, checks, grid lines, or any other type of pattern), a skewing, a flipping (e.g., a horizontal or vertical flip), a highlighting, application of a behavior (e.g., blinking, scrolling, animation, or any other type of behavior), or any other type of transformation of the graphical element(s). For example, in one or more embodiments of the invention, resizing may be applied around the center of a graphical element (i.e., resizing in equal parts around the center), or in any other way. Those skilled in the art will appreciate that, in one or more embodiments of the invention, multiple types of transformation may be possible.

In one or more embodiments of the invention, receiving a transformation value for graphical element(s) may be associated with direct manipulation of the transformation version(s) of the graphical element(s), rotating a dial, adjusting a slider, entering and/or adjusting a textual value, vocalizing a command, any other type of transformation value specification, or any combination thereof. Those skilled in the art will appreciate that receiving a transformation value may involve receiving input from a keyboard, mouse, stylus, light pen, microphone, or any other type of input device. In one or more embodiments of the invention, when a transformation value is received, the associated transformation is immediately applied to the transformation version(s) and/or normal version(s) of the graphical element(s) selected. Alternatively, the transformation may not be applied until the transformation value is accepted. Applying a transformation is described in detail below.

In one or more embodiments of the invention, the transformation value may be associated with a usage criterion for applying the transformation. For example, in one or more embodiments of the invention, the usage criterion may be a number of times a graphical element is used, a time period during which the graphical element is not used, a number of users accessing the graphical element, a dynamic property of the graphical element, or any other type of usage criterion. For example, in a shared calendar interface (e.g., a calendaring application hosted on a network), the usage criterion may be associated with a number of individuals invited to a particular meeting, a number of times a particular task has been viewed, or any other type of usage criterion.

As a specific example, in one or more embodiments of the invention, a usage criterion may be defined for a calendar event in a shared calendar interface, for the event to be displayed in bold print when at least ten users have viewed the event. Thus, after a tenth user views the event, the usage criterion is triggered and the event is subsequently displayed in bold print for all users. Those skilled in the art will appreciate that there are many different ways to associate a usage criterion with multiple users. Further, those skilled in the art will appreciate that, in one or more embodiments of the invention, if a usage criterion is associated with multiple users, the graphical user interface to transform may be a shared graphical user interface viewed on multiple distinct computer systems.

Those skilled in the art will appreciate that in one or more embodiments of the invention, multiple transformation values may be received for the selected graphical element(s), associated with multiple transformations of the graphical element(s). For example, a selection of graphical element(s) may be both resized and rotated. Those skilled in the art will appreciate that many different ways to combine transformations exist.

Returning to discussion of FIG. 1, once a transformation value is received, the transformation value is accepted (Step 120). In one or more embodiments of the invention, if the transformation has already been applied to the normal version(s) of the graphical element(s), then accepting the transformation value simply closes the transformation mode. Alternatively, if the transformation has not yet been applied to the normal version(s), then accepting the transformation value applies the transformation to the normal version(s). However, those skilled in the art will appreciate that in one or more embodiments of the invention, if the transformation value received in Step 115 is associated with a usage criterion for the graphical element(s), as discussed above, then the transformation may not be applied until the usage criterion is met.

In one or more embodiments of the invention, accepting the transformation value involves selecting an acceptance control (e.g., a graphical control, a keyboard input, or any other type of control), vocalizing a command, or any other type of acceptance action. In one or more embodiments of the invention, accepting a transformation value includes an option to save an element filter (i.e., the selection of graphical element(s) identified in Step 110) for future use. Element filters are discussed in detail below.

Next, the transformation mode closes and the method returns to the normal mode of the graphical user interface (Step 125). Those skilled in the art will appreciate that the normal mode of the graphical user interface now includes the accepted transformation. Effectively, the normal mode of the graphical user interface is now a transformed graphical user interface.

Those skilled in the art will appreciate that in one or more embodiments of the invention, the method of FIG. 1 provides functionality to specify specific graphical elements to make more or less visually prominent in a graphical user interface. Accordingly, clutter may be reduced in the graphical user interface without completely removing less frequently used graphical elements. Further, more important and/or more frequently used graphical elements may be made easier to view and/or use, thereby improving the user experience of the graphical user interface.

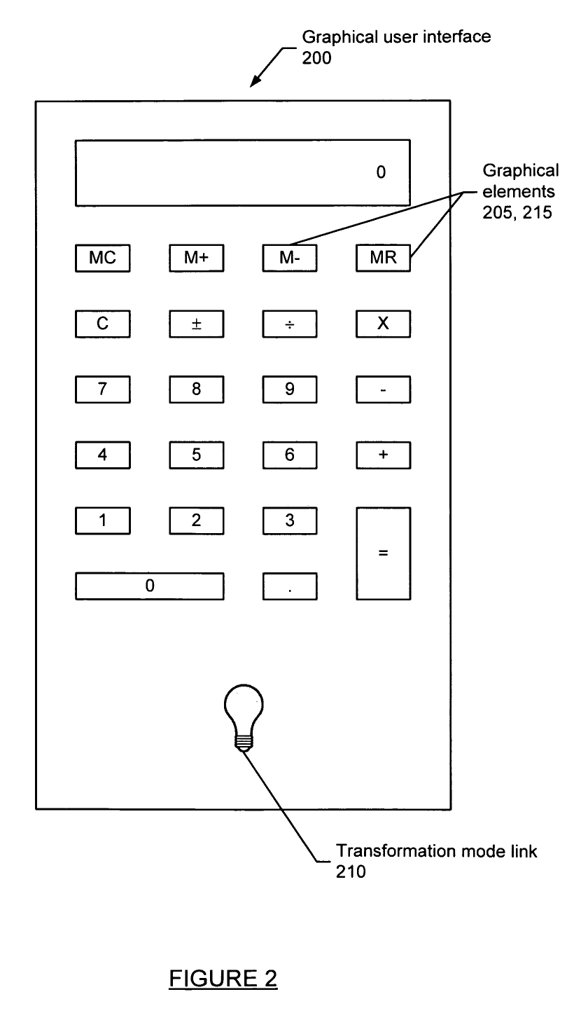

The following discussions of FIGS. 2-6 describe an example of one embodiment of the invention. While the graphical user interfaces shown in FIGS. 2-6 resemble a calculator, those skilled in the art will appreciate that the figures are provided for exemplary purposes only, that the following discussions may be equally well applied to any other type of graphical user interface.

FIG. 2 shows a diagram of a graphical user interface in accordance with one or more embodiments of the invention. Specifically, FIG. 2 shows a diagram of a normal mode of a graphical user interface (200) in accordance with one or more embodiments of the invention. In one or more embodiments of the invention, the graphical user interface (200) includes multiple graphical elements (e.g., 205, 215) and a transformation mode link (210). Specifically, in one or more embodiments of the invention, the graphical elements (e.g., 205, 215) are configured to accept one or more transformations, and the transformation mode link (210) is configured to access a transformation mode of the graphical user interface (200).

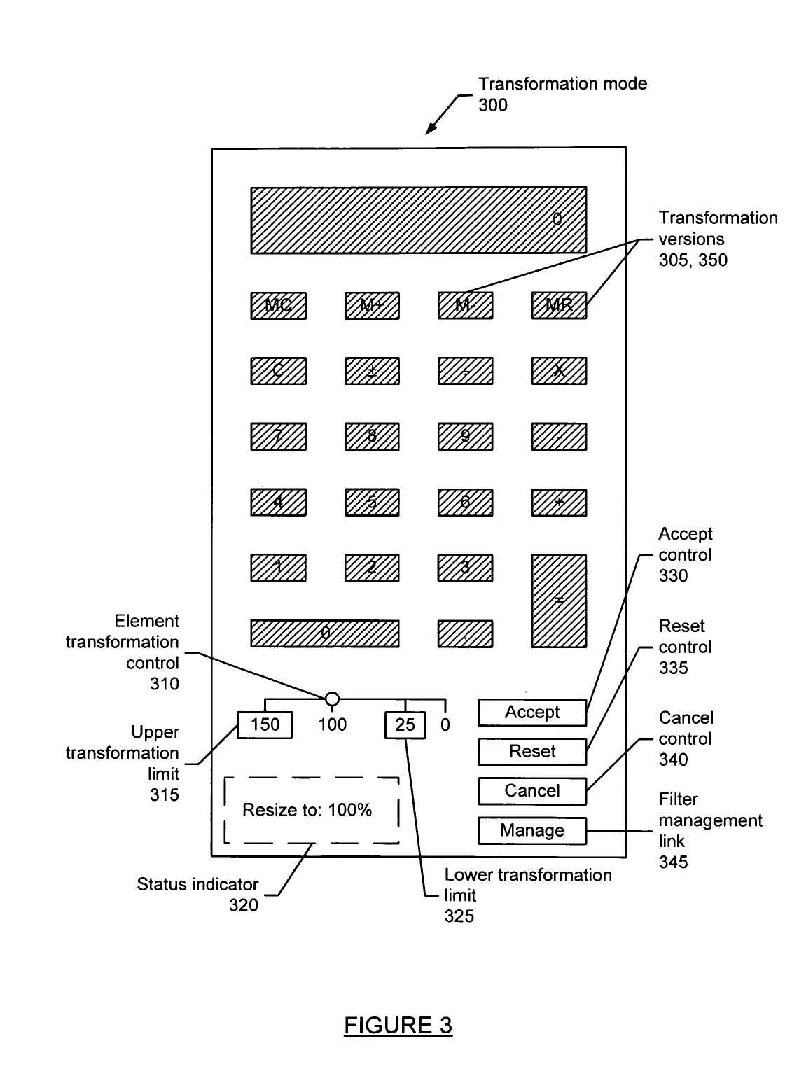

FIG. 3 shows a diagram of a graphical user interface in accordance with one or more embodiments of the invention. Specifically, FIG. 3 shows a diagram of a transformation mode (300) of the graphical user interface (200) in accordance with one or more embodiments of the invention. In one or more embodiments of the invention, the transformation mode (300) may be accessed, for example, by selecting the transformation mode link (210) in the normal mode of the graphical user interface (200). Different types of transformation modes are discussed above.

In one or more embodiments of the invention, the transformation mode (300) includes one or more transformation versions (e.g., 305, 350) of graphical elements (e.g., 205, 215). Different types of transformation versions are discussed above. Further, in one or more embodiments of the invention, the transformation mode (300) includes an element transformation control (310), an upper transformation limit (315), a status indicator (320), a lower transformation limit (325), an accept control (330), a reset control (335), a cancel control (340), and a filter management link (340). These components are discussed in detail below. Those skilled in the art will appreciate that one or more embodiments of the invention may include some or none of these components.

In one or more embodiments of the invention, the element transformation control (310) is configured to accept a specification of a transformation value, as discussed above. Specifically, the transformation value in this example is for resizing one or more graphical elements (e.g., 205, 215). In one or more embodiments of the invention, the element transformation control (310) may be associated with a different type of transformation. Different types of transformation are discussed above. Those skilled in the art will appreciate that in one or more embodiments of the invention, different and/or additional element transformation controls (not shown) may be used, depending, e.g., on the types of transformation available and/or to combine different types of transformation. Further, those skilled in the art will appreciate that many different ways to combine transformations exist.

Further, those skilled in the art will appreciate that the appearance of each element transformation control (e.g., 310) may vary, depending on the type of transformation with which it is associated. For example, in one or more embodiments of the invention, a rotation of a graphical element may involve using a virtual dial having a value range from zero to three hundred and sixty degrees. Further, in one or more embodiments of the invention, changing the color of a graphical element may involve using three separate sliders—for red, green, and blue—each having a value range from zero to two hundred and fifty-five. Those skilled in the art will appreciate that many types of element transformation control exist, and that a given type of transformation may not be limited to a single type of element transformation control.

In one or more embodiments of the invention, the transformation value is limited to the value range indicated by the upper transformation limit (315) and the lower transformation limit (325). Those skilled in the art will appreciate that an upper transformation limit (315) and/or lower transformation limit (325) may restrict the transformation value to a reasonable and/or feasible range. In one or more embodiments of the invention, the status indicator (320) indicates the current transformation value specified by the element transformation control (310).

In one or more embodiments of the invention, the accept control (330) is configured to accept the transformation value specified by the element transformation control (310). Different types of acceptance actions are discussed above. Further, in one or more embodiments of the invention, the accept control (330) is configured to initiate saving an element filter (i.e., a selection of graphical elements) for future use. In one or more embodiments of the invention, initiating saving may involve prompting a user for a decision, saving automatically, or any other type of initiation. Those skilled in the art will appreciate that many different ways to save an element filter exist. Element filters are discussed in detail below. In one or more embodiments of the invention, the transformation mode (300) includes a save control (not shown) for saving an element filter without accepting the transformation value.

In one or more embodiments of the invention, the reset control (335) is configured to reset the transformation mode (300) to an initial state. Those skilled in the art will appreciate that the initial state may be a default state in which no elements of the transformation mode (300) are transformed, a state prior to the most recent accessing of the transformation mode (300), an initial state of a selected graphical element (not shown), or any other type of resetting. In one or more embodiments of the invention, the cancel control (340) is configured to close the transformation mode (300) without accepting any transformation values.

In one or more embodiments of the invention, combinations of transformation versions (e.g. 305, 350) may be selected to obtain an element filter, as discussed below. Accordingly, in one or more embodiments of the invention, the filter management link (345) is configured to access a filter management interface for managing element filters. Use of a filter management interface is discussed in detail below.

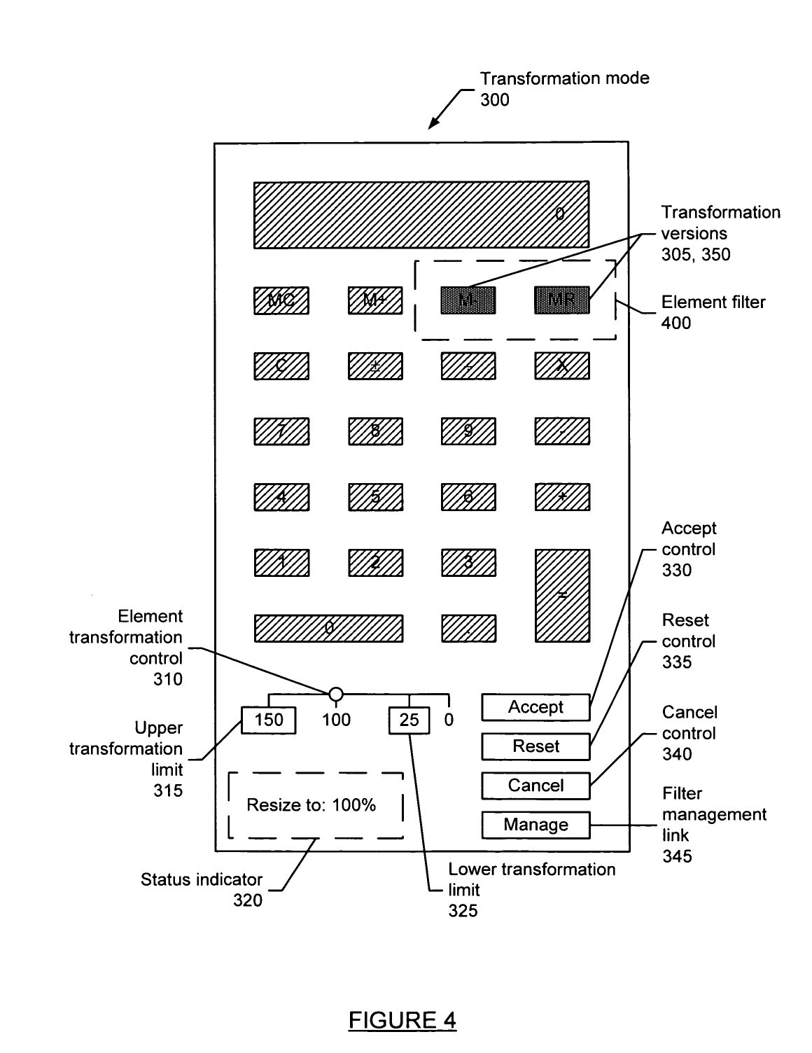

FIG. 4 shows a diagram of a graphical user interface in accordance with one or more embodiments of the invention. Specifically, FIG. 4 shows a diagram of the transformation mode (300), in which transformation versions (305, 350) of graphical elements (205, 215) have been selected to obtain an element filter (400), in accordance with one or more embodiments of the invention. In one or more embodiments of the invention, when the element filter (400) has been obtained, any transformation value received is associated with all the graphical elements (205, 215) represented by the element filter (400).

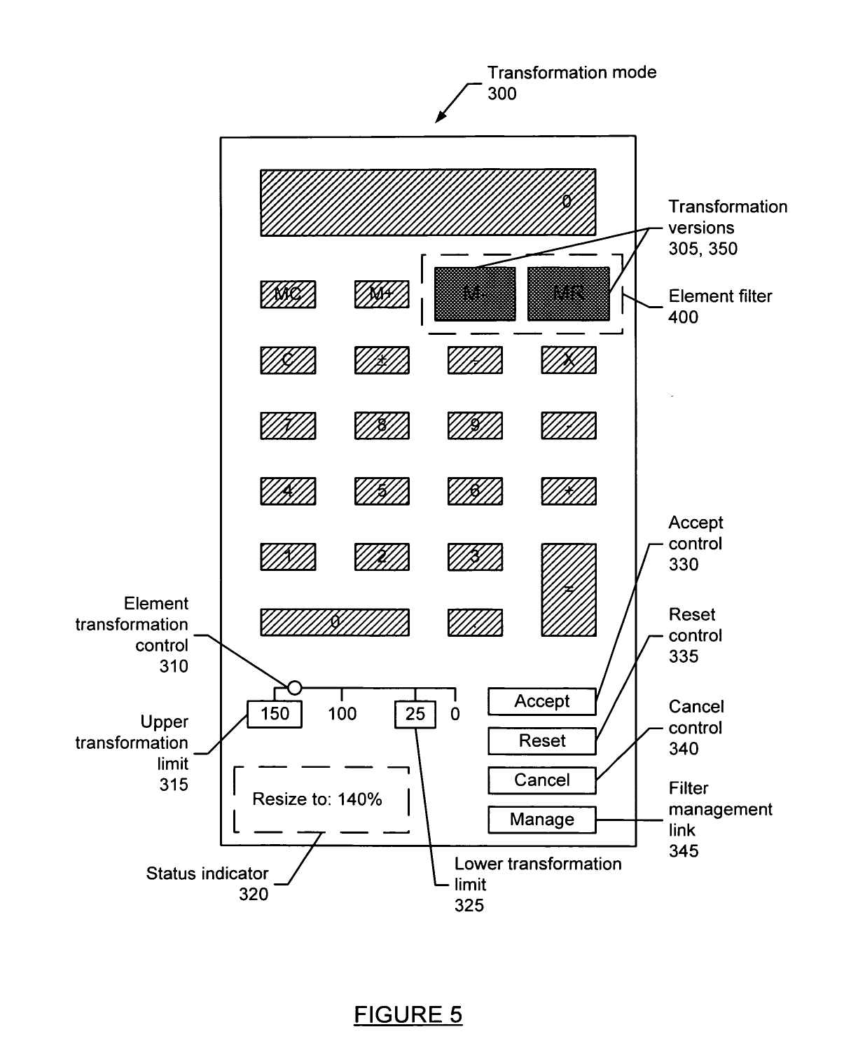

FIG. 5 shows a diagram of a graphical user interface in accordance with one or more embodiments of the invention. Specifically, FIG. 5 shows a diagram of the transformation mode (300), in which a transformation value has been received for the element filter (400), in accordance with one or more embodiments of the invention. As shown in FIG. 5, in one or more embodiments of the invention, the transformation versions (305, 350) may be automatically transformed when the element transformation control (310) is adjusted. Further, in one or more embodiments of the invention, the status indicator (320) may be updated to indicate the received transformation value.

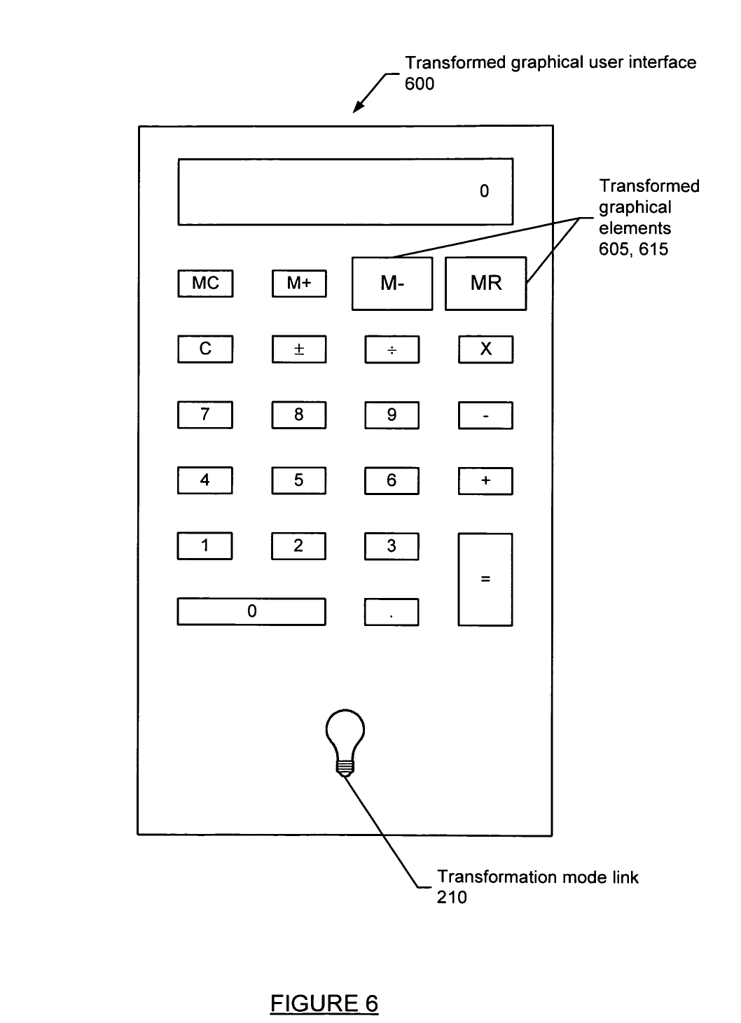

FIG. 6 shows a diagram of a graphical user interface in accordance with one or more embodiments of the invention. Specifically, FIG. 6 shows a diagram of a transformed graphical user interface (600) in accordance with one or more embodiments of the invention. More specifically, the transformed graphical user interface (600) is a product of transforming the graphical user interface (200) using the transformation mode (300). In one or more embodiments of the invention, the transformed graphical user interface (600) may be obtained, for example, by selecting the accept control (330) to close the transformation mode (300) and return to the normal mode of the graphical user interface (200). As shown in FIG. 6, the transformed graphical user interface (600) is identical to the graphical user interface (200) except for the transformed graphical elements (605, 615), which are transformations of the graphical elements (205, 215). Those skilled in the art will appreciate that in one or more embodiments of the invention, if the cancel control (340) was selected instead, then the graphical user interface (200) is not transformed.

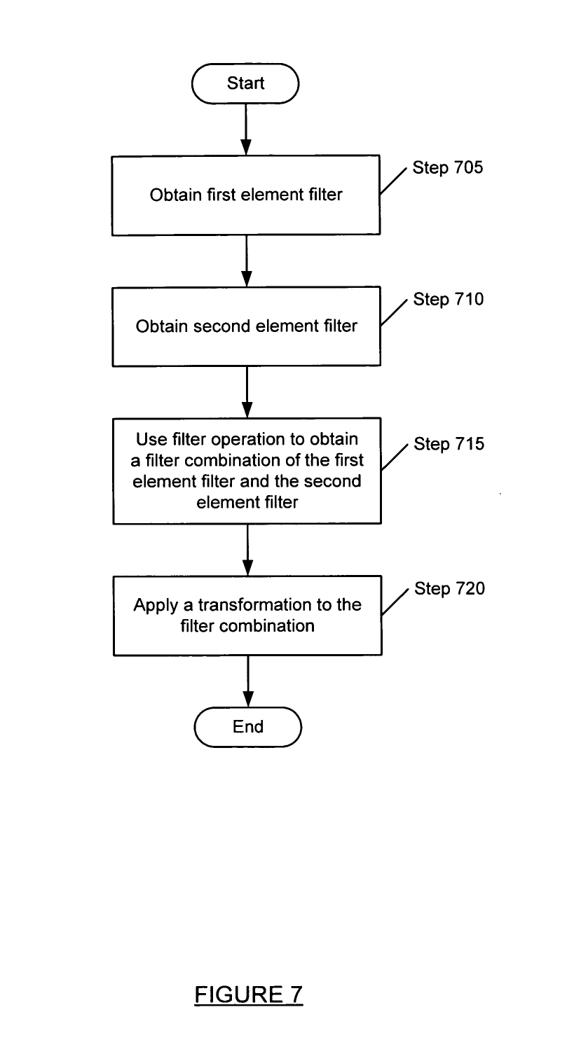

In one or more embodiments of the invention, multiple element filters may be combined to obtain a filter combination. FIG. 7 shows a flow chart in accordance with one or more embodiments of the invention. Specifically, FIG. 7 shows a flow chart of a method for obtaining and using a filter combination in accordance with one or more embodiments of the invention.

Initially, a first element filter is obtained (Step 705). In one or more embodiments of the invention, obtaining an element filter may involve selecting one or more transformation versions of graphical elements, as described above, selecting a predefined element filter from a list or menu, typing a name of an element filter, selecting an icon associated with an element filter, or any other similar type of obtaining. Those skilled in the art will appreciate that the element filter thus obtained may itself be a filter combination, as discussed below. Next, a second element filter is obtained (Step 710). In one or more embodiments of the invention, the second element filter may be obtained separately or in conjunction with the first element filter. Those skilled in the art will appreciate that additional element filters may also be obtained.

Next, a filter operation is used to obtain a filter combination of the first element filter and the second element filter (Step 715). In one or more embodiments of the invention, the filter operation may be a set operation, a logical processing of the first element filter and the second element filter (e.g., conditional program code to determine a combination of the first element filter and the second element filter), a user-defined operation, or any other type of operation. Different types of set operations are discussed in detail below. Those skilled in the art will appreciate that a filter combination thus obtained is an element filter itself, representing a combination of graphical elements (i.e., zero or more graphical elements) represented by the first element filter and the second element filter.

Once the filter combination is obtained, the filter combination may be used to transform the graphical elements represented by the filter combination (Step 720). For example, the filter combination may be loaded into a transformation mode of a graphical user interface (see FIG. 3 for an example of a transformation mode), wherein a user may then specify a transformation value for the filter combination. Those skilled in the art will appreciate that many different ways to apply a transformation to a filter combination exist.

Those skilled in the art will appreciate that in one or more embodiments of the invention, the method of FIG. 7 provides a means to apply complex transformations and/or combinations of transformations to groups of graphical elements. Further, when predefined element filters are used, the method of FIG. 7 provides a means to manage the visual appearance of specific groups of graphical elements repeatedly and/or in combination.

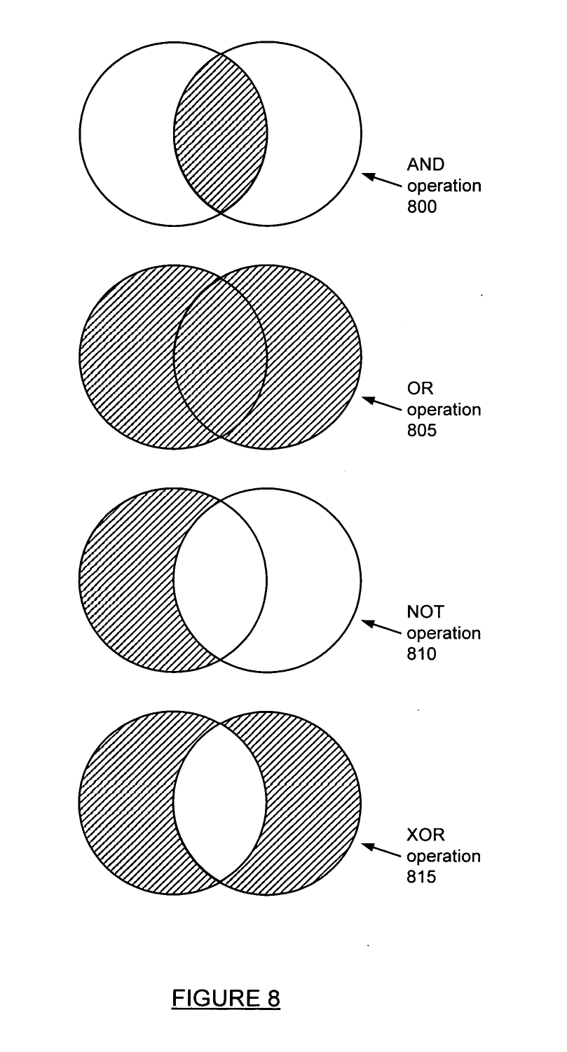

FIG. 8 shows a diagram of set operations in accordance with one or more embodiments of the invention. Specifically, FIG. 8 shows a diagram of set operations that may be used to obtain a filter combination of a first element filter and a second element filter in accordance with one or more embodiments of the invention. In one or more embodiments of the invention, the AND operation (800) may be used to obtain a filter combination of graphical elements that both element filters have in common, the OR operation (805) may be used to obtain a filter combination of graphical elements that are represented by either element filter, the NOT operation (810) may be used to obtain a filter combination of elements that are represented by only one of the element filters, and the XOR operation (815) may be used to obtain a filter combination of only those graphical elements that the two element filters do not have in common. Those skilled in the art will appreciate that in one or more embodiments of the invention, some or none of these operations may be available.

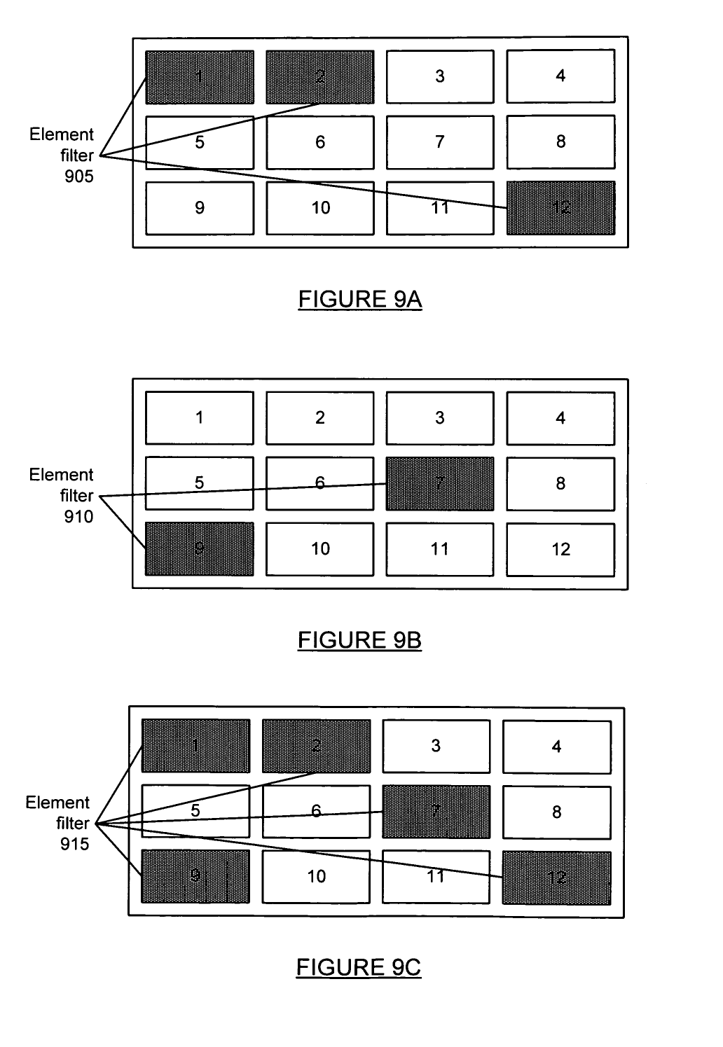

FIGS. 9A-9C show diagrams of element filters (905, 910, 915) in accordance with one or more embodiments of the invention. Specifically, element filter (915) is a filter combination of element filter (905) and element filter (910), using an OR operation (see OR operation (805) of FIG. 8). More specifically, those skilled in the art will appreciate that element filter (915) represents all graphical elements represented by element filter (905) and element filter (910).

Those skilled in the art will appreciate that if an AND operation had been used instead (see AND operation (800) of FIG. 8), then element filter (915) would not represent any graphical elements at all, since element filter (905) and element filter (910) do not have any graphical elements in common. Further, those skilled in the art will appreciate that if element filter (905) and element filter (910) had any graphical elements in common, then an AND operation would have included only those common graphical elements in the filter combination.

Those skilled in the art will appreciate that if a NOT operation had been used instead (i.e., element filter (905) NOT element filter (910)) (see NOT operation (810) of FIG. 8), then element filter (915) would represent all graphical elements represented by element filter (905), since element filter (905) and element filter (910) do not have any graphical elements in common. Further, those skilled in the art will appreciate that if element filter (905) and element filter (910) had any graphical elements in common, then a NOT operation would have excluded those common graphical elements from the filter combination.

Those skilled in the art will appreciate that if an XOR operation had been used instead (see XOR operation (815) of FIG. 8), then element filter (915) would represent all graphical elements represented by element filter (905) and element filter (910), since element filter (905) and element filter (910) do not have any graphical elements in common. Further, those skilled in the art will appreciate that if element filter (905) and element filter (910) had any graphical elements in common, then an XOR operation would have excluded those common graphical elements from the filter combination.

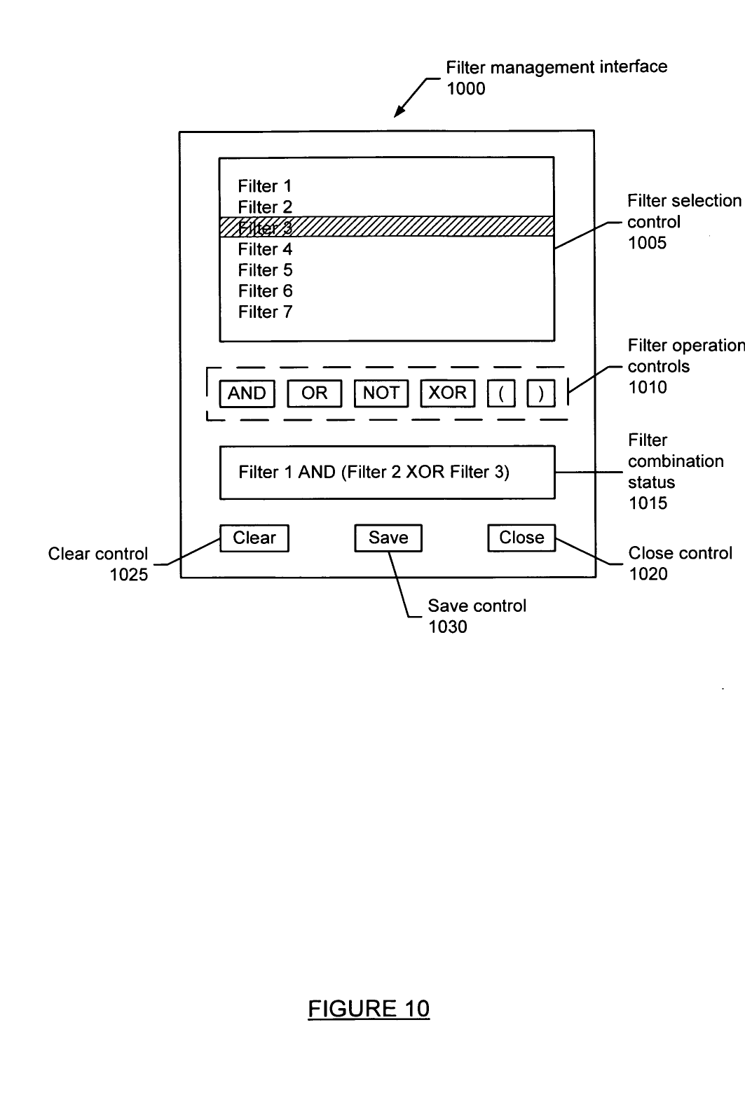

FIG. 10 shows a diagram of a graphical user interface in accordance with one or more embodiments of the invention. Specifically, FIG. 10 shows a diagram of a filter management interface (1000) in accordance with one or more embodiments of the invention. In one or more embodiments of the invention, the filter management interface (1000) may be accessed, for example, using a filter management link, as discussed above with respect to FIG. 3.

In one or more embodiments of the invention, the filter management interface (1000) includes a filter selection control (1005), one or more filter operation controls (1010), a filter combination status (1015), a close control (1020), a save control (1030), and a clear control (1025). Each of these components is described in detail below. Those skilled in the art will appreciate that in one or more embodiments of the invention, the filter management interface (1000) may include only a subset of these components.

In one or more embodiments of the invention, the filter selection control (1005) is configured to provide access to element filters that are available to be combined together. In one or more embodiments of the invention, the filter selection control (1005) may be a list, a menu, an icon group, or any other type of element filter presentation.

In one or more embodiments of the invention, the filter operation controls (1010) are configured to provide access to filter operations that are available for obtaining filter combinations. For example, as shown in FIG. 10, the filter operation controls (1010) may provide a control for each set operation described in FIG. 8. Further, in one or more embodiments of the invention, the filter operation controls (1010) may include syntax controls (e.g., the parentheses shown in FIG. 10, or any other type of syntax) for defining logical precedence of the filter operation controls. Those skilled in the art will appreciate that specific operation precedence rules (e.g., mathematical precedence rules) may additionally or alternatively be used.

In one or more embodiments of the invention, the filter combination status (1015) may be configured to display the currently defined filter combination, based on using the filter selection control (1005) and the filter operation controls (1010). In one or more embodiments of the invention, the filter combination status (1015) may simply represent the order in which controls (i.e., filter selection control (1005) and filter operation controls (1010)) were used, or may include additional syntax and/or formatting.

In one or more embodiments of the invention, the close control (1020) is configured to close the filter management interface (1000). In one or more embodiments of the invention, closing the filter management interface (1000) may transfer access to a transformation mode of a graphical user interface, a normal mode of the graphical user interface, or any other interface. Specifically, in one or more embodiments of the invention, closing the filter management interface (1000) may transfer access to the transformation mode, wherein the currently defined filter combination is applied to the transformation mode (see element filter (400) of FIG. 4 for one example of how an element filter may be applied to a transformation mode).

In one or more embodiments of the invention, the save control (1030) is configured to save the currently defined filter combination to the list of available element filters. Those skilled in the art will appreciate that a filter combination thus saved may then be available via the filter selection control (1005). In one or more embodiments of the invention, the clear control (1025) is configured to clear the currently defined filter combination. Those skilled in the art will appreciate that in one or more embodiments of the invention, the filter combination status (1015) may also be cleared.

Those skilled in the art will appreciate that in one or more embodiments of the invention, the graphical user interface of FIG. 10 provides a means for users to manage groups of graphical elements based on predefined element filters. Further, the ability to manage predefined element filters provides a means to manage the visual appearance of specific groups of graphical elements repeatedly.

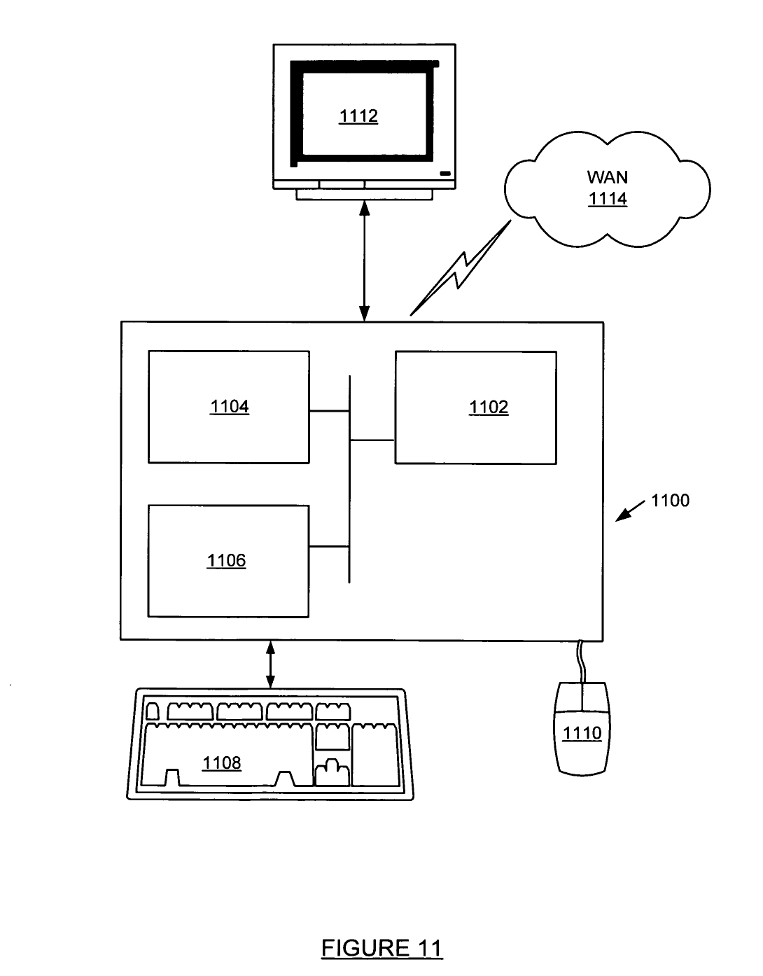

The invention may be implemented on virtually any type of computer regardless of the platform being used. For example, as shown in FIG. 11, a computer system (1 100) includes a processor (1102), associated memory (1104), a storage device (1106), and numerous other elements and functionalities typical of today's computers (not shown). The computer (1100) may also include input means, such as a keyboard (1108) and a mouse (1110), and output means, such as a monitor (1112). The computer system (1100) may be connected to a local area network (LAN) or a wide area network (e.g., the Internet) (1114) via a network interface connection (not shown). Those skilled in the art will appreciate that these input and output means may take other forms.

Further, those skilled in the art will appreciate that one or more elements of the aforementioned computer system (1100) may be located at a remote location and connected to the other elements over a network. Further, the invention may be implemented on a distributed system having a plurality of nodes, where each portion of the invention (e.g., graphical user interface, graphical elements, transformation mode, transformation versions, element transformation control, filter management interface, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computer readable medium comprising executable instructions for transforming a graphical user interface by:
accessing a transformation mode of the graphical user interface, wherein the graphical user interface comprises a plurality of graphical elements;
selecting a first graphical element from the plurality of graphical elements;
receiving a transformation value associated with a transformation of the first graphical element; and
applying the transformation to the first graphical element to obtain a transformed graphical user interface.

2. The computer readable medium of claim 1, wherein applying the transformation to the first graphical element comprises applying the transformation in a normal mode of the graphical user interface.

3. The computer readable medium of claim 1, wherein the transformation mode of the graphical user interface comprises an overlay of the graphical user interface.

4. The computer readable medium of claim 1, wherein selecting the first graphical element comprises selecting a transformation version of the first graphical element.

5. The computer readable medium of claim 1, wherein the first graphical element is a scaled vector graphic.

6. The computer readable medium of claim 1, wherein the first graphical element is an input control.

7. The computer readable medium of claim 1, further comprising executable instructions for transforming a graphical user interface by:
selecting a second graphical element from the plurality of graphical elements to create an element filter comprising the first graphical element and the second graphical element, wherein the transformation is applied to the element filter.

8. The computer readable medium of claim 1, wherein applying the transformation transforms the first graphical element in the transformation mode.

9. The computer readable medium of claim 1, wherein the transformation is a resizing of the first graphical element around a center of the first graphical element.

10. The computer readable medium of claim 1, wherein the transformation value comprises a usage criterion defining when to apply the transformation associated with the first graphical element.

11. The computer readable medium of claim 10, wherein the usage criterion is associated with a plurality of users of the graphical user interface.

12. A computer readable medium comprising executable instructions for transforming a graphical user interface by:
obtaining a first element filter associated with a first graphical element of the graphical user interface;
obtaining a second element filter associated with a second graphical element of the graphical user interface;
using a filter operation to combine the first element filter and the second element filter, to create a filter combination associated with the first graphical element and the second graphical element; and
transforming the first graphical element and the second graphical element, using the filter combination, to generate a transformed graphical user interface.

13. The computer readable medium of claim 12, wherein the first graphical element is a scaled vector graphic.

14. The computer readable medium of claim 12, wherein the first graphical element is an input control.

15. The computer readable medium of claim 12, wherein the filter operation comprises a set operation.

16. The computer readable medium of claim 12, wherein transforming the combination of the first element and the second element comprises resizing the combination of the first element and the second element.

17. The computer readable medium of claim 12, wherein transforming the first graphical element and the second graphical element is triggered based on a usage criterion associated with the filter combination.

18. The computer readable medium of claim 17, wherein the usage criterion is associated with a plurality of users.

19. The computer readable medium of claim 12, wherein transforming the first graphical element and the second graphical element is performed in a transformation mode of the graphical user interface.

20. A graphical user interface displaying a transformation mode of a graphical user interface, comprising:
a plurality of graphical elements of the graphical user interface, wherein each graphical element in the plurality of graphical elements is configured to be selected; and
an element transformation control configured to accept a transformation value,
wherein the transformation value is associated with a transformation of a selected graphical element, and
wherein applying the transformation to the selected graphical element results in a transformed graphical user interface.
